(19) United States
(12) Patent Application Publication
(10) Pub. No.: US 2016/0221328 A1
(43) Pub. Date: Aug. 4, 2016

(54) METHOD AND DEVICE FOR SURFACE TREATMENT OF A THREE-DIMENSIONAL BODY

(71) Applicant: TILL GMBH, Kelkheim (Taunus) (DE)

(72) Inventor: Volker TILL, Hofheim am Taunus (DE)

(21) Appl. No.: 14/917,583

(22) PCT Filed: Sep. 12, 2014
(86) PCT No.: PCT/EP2014/069527

§ 371 Date: Mar. 9, 2016

(30) Foreign Application Priority Data
Sep. 13, 2013 (DE) 10 2013 110 125.9

(51) Int. Cl. B41F 23/00; C23C 4/01

(52) U.S. Cl. CPC B41F 23/007; C23C 4/01

(57) ABSTRACT

A method for surface pretreatment of a three-dimensional body for preparing a three-dimensional surface of the body for printing includes, for purposes of at least one of cleaning or adaptation to a surface voltage of a printing material, moving the surface to be printed relative to a surface treatment apparatus so that the whole of the surface to be printed is treated. The three-dimensional body is treated in a conveyor track of a conveyor apparatus with a surface treatment. The three-dimensional body is moved past the surface treatment apparatus along the conveyor track of the conveyor apparatus at an adjustable transport speed in a transport direction and is simultaneously moved about its own axis in such a way that the surface to be printed is moved past the surface treatment apparatus in or against the transport direction due to the independent movement of the body about its own axis.

### CROSS-REFERENCE TO PRIOR APPLICATIONS

This application is a U.S. National Stage Application under 35 U.S.C. §371 of International Application No. PCT/EP2014/069527 filed on Sep. 12, 2014, and claims benefit to German Patent Application No. DE 10 2013 110 125.9 filed on Sep. 13, 2013. The International Application was published in German on Mar. 19, 2015 as WO 2015/036555 A2 under PCT Article 21(2).

### FIELD

The invention relates to a method and a device for surface treatment of a three-dimensional body for preparing a three-dimensional surface of the body for printing, especially with ink. In the framework of the method, for the purposes of cleaning and/or adaptation to the surface voltage of the printing material or printing color (ink), the surface to be printed is moved relative to a surface treatment apparatus, so that the whole of the surface to be printed can be treated.

### BACKGROUND

Surfaces of three-dimensional bodies that need to be treated, in particular of containers like plastic or glass bottles, that are nonpolar, highly electrically insulating and water-repellent. For this reason, the printing material (printing color or ink) does not adhere well to these surfaces. Prior to printing directly on these surfaces, it is therefore desirable to increase the polarity of the surface, thus significantly increasing the wettability and chemical affinity for the adhesion of the printing material in particular.

Known methods for treatment of such surfaces to be printed include a plasma treatment, flame treatment, fluorination, ozone treatment, UV light treatment and/or a corona treatment.

During surface treatment, the surface energy of the surface to be printed is aligned to the surface voltage of the printing material (printing color or ink) and the interfacial tension between the surface to be printed and the printing material (usually liquid) is adjusted.

Apart from the importance of the above-mentioned adhesion of the printing material to the surface to be printed, this step is also important for achieving the intended resolution, so that the liquid printing material that is usually applied in drops does not run and the desired resolution is achieved.

In case of two-dimensional surfaces to be printed, particularly flat substrates, e.g. foils, a corona treatment is normally performed for this purpose, whereby the substrate is exposed to an electrical high voltage discharge occurring throughout the substrate between a grounded carrier electrode for the substrate and a tightly attached insulated electrode.

Such a treatment is usually not possible for three-dimensional bodies, thus, especially in cases of containers like bottles, the surface is prepared for direct printing either by means of a flame treatment or a treatment with especially atmospheric plasma.

During atmospheric plasma treatment, an electrical discharge of a high frequency current with a high voltage occurs between two electrodes, whereby the resulting plasma jet is bent or deflected in the flow direction by means of compressed air, so that the plasma jet can strike the surface to be treated. Using this method it becomes possible to treat the surface of three-dimensional bodies—of which the surface itself preferably extends a three-dimensionally—without the need of having to arrange the body between the electrodes.

For such plasma treatment, there are existent plasma jet nozzles that produce a flat jet with a width of 10 to 15 mm. However, the jet does not display a homogeneous intensity distribution between its center and its sides.

Instead, the plasma intensity decreases toward the sides, making it difficult to achieve a homogeneous surface treatment of the entire surface to be printed. Furthermore, there are also existent plasma emitters, in which the concentrated plasma jet is conducted so to provide more homogeneous distribution through a rapidly rotating outlet nozzle, which results in a circular plasma jet that scans a wider surface in the form of a circular segment and, with an even rotation speed of the outlet nozzle, achieves an even intensity distribution of the plasma jet inside the circular segment.

In the generic US 2013/0019566 A1, a printing machine is disclosed having a conveyor that leads through a corona tunnel and guides the containers to be printed to the printing machine. Inside the corona tunnel, the containers are pre-treated for printing. In EP 2 479 036 A1, a similar system for printing containers is described, where the containers are guided through a pre-treatment station onto a star wheel placement device that places the containers into the printing machine.

In DE 10 2013 208 061 A1, it is mentioned with regard to pre-treatment prior to printing on a container that a surface treatment particularly in the form of cleaning in a separate pre-treatment star wheel conveyor can be performed. A similar pre-treatment star wheel conveyor is described in US 2009/0206616 A1 for cleaning the bottles prior to filling.

The US 2012/0260955 also discloses a cleaning station prior to filling the container that is formed from a preform. In the context of drawing the preform to become the container, a surface treatment involving heating by means of a clamp element is described, whereby the clamp element encircles the complete circumference of the preform.

According to the disclosure of US 2006/00144261 A1, in a system for printing on plastic containers, it is provided that the containers are turned between two consecutive pre-treatment and printing steps, while the containers are moving from the first station to the printing station.

While two-dimensional surfaces to be printed are quite simply treated by moving the surface treatment apparatus over the surface to be treated, in cases of three-dimensional surfaces, the additional axis needs to be controlled in order to be able to expose the entire surface to be printed to a surface treatment of equal intensity. Systems that simply pass each other in a translational manner, which works for two-dimensional surfaces, do not achieve this. Rather, it is necessary for the surface treatment apparatus to scan the body surface in two dimensions.

Hence, the known surface treatment apparatuses for treatment of three-dimensional bodies usually have a complex mechanical design and require a significant control effort in order to achieve an even surface treatment of the printing surface. These surface treatment apparatuses are usually integrated in the printing machines, requiring a significant amount of space for the plasma device and the two-dimensional scanning.

### SUMMARY

In an embodiment, the present invention provides a method for surface pretreatment of a three-dimensional body for preparing a three-dimensional surface of the body for printing includes, for purposes of at least one of cleaning or adaptation to a surface voltage of a printing material, moving the surface to be printed relative to a surface treatment apparatus so that the whole of the surface to be printed is treated. The three-dimensional body is treated in a conveyor track of a conveyor apparatus with a surface treatment. The three-dimensional body is moved past the surface treatment apparatus along the conveyor track of the conveyor apparatus at an adjustable transport speed in a transport direction and is simultaneously moved about its own axis in such a way that the surface to be printed is moved past the surface treatment apparatus in or against the transport direction due to the independent movement of the body about its own axis.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 schematic view from above of a device for surface treatment of a three-dimensional body according to a first embodiment.

FIG. 2 the device according to FIG. 1 in a side view in transport direction;

FIG. 3 view from above on the surface treatment apparatus according to FIG. 1 and FIG. 2;

FIG. 4 schematic view from above of a second embodiment of the device according to the invention for surface treatment or a three-dimensional body;

FIG. 5 schematic view from above of a third embodiment of the device according to the invention for surface treatment or a three-dimensional body;

FIG. 6 schematic sectional view of the embodiment according to FIG. 5;

FIG. 7 schematic view from above on a fourth embodiment that is a variant of the device according to the invention according to FIG. 5 with a changed rotational drive for the three-dimensional bodies; and

FIG. 8 schematic view from above of a fifth embodiment of the device according to the invention for surface treatment of a three-dimensional body.

### DETAILED DESCRIPTION

In an embodiment, the present invention provides a method for surface treatment for three-dimensional bodies of the above mentioned type, which allows an easier integration of the surface treatment into the printing system.

In an embodiment, the method provides for the three-dimensional body to undergo the surface treatment in a conveyor track of a conveyor apparatus, in which the body is transported to a printing machine or printing station of the printing system. In other words, the method presents the body's surface treatment apparatus to be arranged on a conveyor track of a conveyor apparatus, particularly on the conveyor track leading towards the printing machine or printing station of the printing system. A printing system that is integrated—e.g. into a production line or cleaning line for the three-dimensional body, e.g. a plastic bottle—usually has a conveyor apparatus that is used for transporting the three-dimensional body on a conveyor track towards the printing machine or printing station. Thus, an important feature of an embodiment of the invention is to arrange the surface treatment on such a conveyor track, so that the bottle undergoes the surface treatment on its way to the printing machine or printing station. It is easier to arrange the surface treatment apparatus on such a conveyor track, as there is usually more space available than inside the printing machine or the printing station itself. Moreover, control of the surface treatment apparatus can be designed more flexibly, as the surface treatment process, in terms of time and space, is separate from the process of printing on the surface.

The surface treatment according to an embodiment of the invention can be performed in a clocked or continuous manner, whereby, depending on the build of the device according to an embodiment of the invention, naturally only one or several three-dimensional bodies can be treated at once.

When performing clocked surface treatment, it can be especially provided for the surface treatment to be performed during the standstill phase of the three-dimensional bodies on the conveyor track, i.e. while the three-dimensional body is not moving on the conveyor track. During standstill, the three-dimensional body—while immovable relative to the conveyor track—can then be set into independent motion, in order to be moved past the surface treatment apparatus. In case of the three-dimensional body being a bottle, it can e.g. be set in rotation about one of the body's own axes, preferably the central axis. A particularly preferred embodiment for this case will be described below.

In order to enable the surface treatment of a three-dimensional body to be performed during the continuous movement of said body along a conveyor track, it is provided according to the invention that the three-dimensional body on the conveyor track of the conveyor apparatus is moved past the surface treatment apparatus in a settable, possibly adjustable and/or configurable transport speed in transport direction while being simultaneously moved, particularly turned, about an independent axis in such a way that the surface to be printed is moved at an independent speed, preferably at a constant distance, past the surface treatment apparatus in the transport direction or against the transport direction due to the independent motion of the body about an independent body axis.

By way of this proposed overlaid movement of the body according to an embodiment of the invention, i.e. by the translational movement of the body in transport direction and the simultaneous independent motion of the body about its independent axis, the entire surface of the three-dimensional body that is to be printed can be moved past the surface treatment apparatus during the movement of the body along the conveyor track in such a way that, within the framework of this continuous motion sequence, a surface treatment of the entire surface to be printed is possible, even with surfaces formed in three dimensions. This overlaid movement presents a possibility to move a three-dimensional surface according to the invention in its entirety past a surface treatment apparatus without the requirement for the surface treatment apparatus to completely cover the surface to be printed, and it can be handled in a technically simple way.

The proposed movement of the three-dimensional body past the surface treatment apparatus can be substantially designed as a relative movement, i.e. the three-dimensional body is moved past a surface treatment apparatus that is fixed in space, the surface treatment apparatus is moved past the body that is fixed in space (this option, however, would require clocking according to the invention, which, at least for this embodiment of a continuous surface treatment, should preferably be avoided), or the three-dimensional body and the surface treatment apparatus are moved in transport direction, each with a different speed. The latter would also result in a relative movement of the three-dimensional body and surface treatment apparatus in transport direction. However, the preferred embodiment for this variant is such that the three-dimensional body is moved past the surface treatment apparatus that is fixed in space. From a technical point of view, this is the simplest option to be realized, as the surface treatment apparatus, especially if composed of plasma or gas burner equipment, requires both careful adjustment and supply of gas or high voltage power, so that the variant least susceptible to faults consists of installing this surface treatment apparatus firmly at the conveyor track of the conveyor apparatus in a stationary way.

Independent of whether using a clocked or continuous surface treatment in accordance with the description above—according to an especially preferred variant of the proposed invention, the three-dimensional body can in particular be a container to be printed, for example a plastic and/or glass bottle.

Independent of the type of three-dimensional body and/or the type of surface treatment, the surface to be printed is preferably arched in a three-dimensional manner, particularly rounded, so that the surface can be rolled against a mating surface. Simply put, the three-dimensional body can therefore be formed in a cylindrical and/or rotationally symmetrical manner in the area of the surface to be printed. However, according to the invention, the three-dimensional body is not limited to this particularly preferred and easy-to-handle form, but can also be a polygonal body with an approximately circular shape or a body with an elliptical shape.

The surface treatment according to an embodiment of the invention is in particular a plasma treatment, especially a treatment with atmospheric plasma, with plasma emitters that are preferably configured as rotating outlet nozzles. A further preferred option for surface treatment is a flame treatment, especially with gas-fired burners. The plasma emitters and/or gas-fired burners are preferably provided in an arrangement (array), in which they cover at least an area of the surface of the three-dimensional body to be printed. Preferably, by this arrangement of the plasma emitters and/or gas-fired burners, one dimension of the surface to be treated is covered, particularly the one running transversely or diagonally to the transport direction. The arrangement of the plasma emitters and/or gas-fired burners constitutes the surface treatment apparatus.

According to a preferred further development of the proposed method in accordance with the invention, it can be provided—independently of the surface treatment type—that the three-dimensional body is rotated about its own axis, whereby the body's own axis is preferably a rotationally symmetrical axis of a body that is rotationally symmetrical in the area of the surface to be printed. In such a case, the movement of the three-dimensional body can be achieved in a particularly simple manner by placing the body in a separate turning device that is externally driven and—in case of a continuous surface treatment—is preferably moved with the conveyor apparatus. In this embodiment, a movement apparatus for moving the three-dimensional body about an own axis can therefore be separately designed from a carrying apparatus for moving the three-dimensional body past the surface treatment apparatus, e.g. as a driven rotary disc with a receptacle for the three-dimensional body, as driving rollers or similar. Of course, it is also a preferred item of this invention, that the carrying apparatus and the movement apparatus are to be designed as a combined apparatus that simultaneously effect the combined movement of the body required for the continuous surface treatment according to this invention. For this purpose, one option to be considered is a belt drive that will be described below in further detail. This belt drive would engage the three-dimensional body with two separately driven belts, running at different speeds, with a frictional connection, preferably counter-rotating with regard to their contact surface at the three-dimensional body.

Especially in this case, but fundamentally with any type of surface treatment, according to a particularly preferred embodiment of the proposed invention, the movement of the body about its own axis can be achieved by rolling the three-dimensional body against a fixed or moving railing by the motion of a butting surface that is preferably abutting against the three-dimensional body opposite the railing, whereby the three-dimensional body is on the one hand pressed against the railing in a force-fit manner, particularly by the butting surface, and on the other hand is rolled against the railing transversely to the pressing direction, preferably in the transport direction or against the transport direction. The direction of the butting surface movement is preferably also designed to be in transport direction or against the transport direction. In a simple embodiment, the butting surface can be provided e.g. by rubberized rolls that are spaced around the circumference of the three-dimensional body and arranged at least on two different points while exerting an initial tension of the body against the railing. The railing can also be formed by rolls, e.g. counter-rotational rolls.

Additionally, it is also possible according to the invention for the railing to be moved in the direction of the movement of the butting surface or against the direction of the movement of the butting surface. This allows a simple adjustment of the rotation direction of the three-dimensional body and also of the turning speed, especially during the simultaneous translational transport of the three-dimensional body on the conveyor track. Thus, this type of drive enables the translational motion of the body and the independent motion of the body to be combined in a simple way according to the invention. Consequently, this drive combines the previously defined carrying apparatus and movement apparatus into one apparatus.

According to a particularly preferred embodiment, the movement of the butting surface and/or the railing can be brought about by a driven belt that is driven by a motor and is preferably adjustable in speed, whereby the driven belt, especially as butting surface and/or railing, abuts against the three-dimensional body in a force-fit manner, so that the belt movement turns the body about its own axis and, with different speeds of the belts, also advances it in a translational way. Such a belt drive can be simply realized especially in conventional conveyor systems, and it has the advantage that the possibly existing rolls can be used for fixating the three-dimensional body and/or pressing the belt against the body in a force-fit manner without the rolls needing to be driven themselves. These rolls can be used according to the invention in order to pressurize the belt, e.g. in a spring-loaded manner, against the three-dimensional body in the direction of the body.

Especially in case of a clocked surface treatment, it can be advantageous to bring about the independent motion of the three-dimensional body that is motionless relative to the conveyor track, i.e. is not transported along the conveyor track, e.g. by driven rolls that are preferably arranged at such a distance that one roll engages with two three-dimensional bodies, particularly bottles, in a force-fit manner and in such a way that the two three-dimensional bodies, when abutting against the railing that can be designed e.g. as a belt or as counter-rotational rolls, are pressed apart to such an extent that they do not rub against each other when rotating about their own axis. In one variant, these rolls can drive a belt that is stretched on the driven rolls and that abuts against the three-dimensional body with a wider surface, thus enabling an even better power transmission onto the three-dimensional body.

Furthermore, preferably two rolls always engage with one three-dimensional body at the same time in order to secure the three-dimensional body against the railing. Hereby, the driven rolls are arranged in such a way that they strike the three-dimensional bodies at an angle, so as not to cause any self-locking effect with the three-dimensional body, i.e. the at least two rolls engage with the three-dimensional body while rotating in the same direction. This drive is particularly suitable for three-dimensional bodies with a cylindrical or at least rounded basic form, e.g. bottles that have a round cross-section.

According to a particularly preferred embodiment of the proposed method, it is provided in the invention that, in case of a continuous surface treatment, the transport speed and the own speed of the three-dimensional body are adjusted to each other in such a way that the surface treatment apparatus treats every area of the surface approximately for the same amount of time and/or according to the same level of intensity.

Such a setting or coordination of the transport speed and the own speed of the three-dimensional body is possible e.g. based on geometrical considerations, in which the independent motion and the transport movements of the body are superimposed thus creating a location-time analysis that provides information about how long every surface area of the surface to be printed is exposed to the impact of the surface treatment apparatus. Thereby, the time-related and/or location-related intensity progression of the surface treatment apparatus can also be taken into consideration, e. g. in case of rotating plasma emitters that in one turning position treat one upper circular segment on each of the surfaces. To make matters simple, such geometrical considerations can be performed by creating a computer model of the surface treatment and the derivation of the suitable speeds in consideration of the operating parameters of the surface treatment apparatus, whereby the computer model is implemented in a suitable control unit. Where appropriate, the control unit can have a regulation option for regulating the transport speed and the independent speed depending on the results of the computer model. To this end, it is particularly advantageous, if the transport speed and the independent speed of the body as well as, where appropriate, the time-related and/or location-related intensity progression of the surface treatment apparatus can be entered into the computer model.

In case of a clocked surface treatment, it can be provided according to the invention that the surface treatment of the three-dimensional body is performed during a standstill in the direction of the conveyor track, i.e. clocked or performed during a standstill time of the three-dimensional body in relation to the transport in the conveyor apparatus, i.e. during a transport break. Thereby, the three-dimensional body is moved about its own axis, particularly turned, and in that way moved past the surface treatment apparatus. During the movement of the three-dimensional body about its own axis, the three-dimensional body and the surface treatment apparatus are displaced relative to each other in the direction of the body's own axis, i.e. the rotation axis, according to the invention, whereby the speed of the movement about the body's own axis, particularly of the rotation, and the displacement movement about the axis are coordinated in such a way that the surface of the three-dimensional body is treated by the surface treatment apparatus in the form of a helical line. This movement can also be created by geometrical considerations e.g. by way of a computer model and a suitable control of the drives, in a similar fashion as described above.

With these means, similar to the overlaid turning and conveying movement of the three-dimensional body in case of continuous surface treatment, the surface of the three-dimensional body that is to be treated and later printed is treated comprehensively, i.e. over the entire surface, with the same dose of intensity and treatment duration, because the surface treatment apparatus scans every part of the surface to be treated in the same manner and over the same time period. When using the clocked pre-treatment method that is also called discontinuous method, this is achieved by treating the surface in the form of a helical line. This results in a series of oblique tracks that run in the form of a helical line and are laid side by side. They ensure the equal treatment of the entire surface of the three-dimensional body (to be treated) from one first incomplete turn to one last incomplete turn.

If we compare this particularly preferred variant of a discontinuous or clocked surface treatment according to the invention with a treatment in which the surface treatment is switched on during the independent motion (independent turning) of the body and switched off again after one revolution (without including a helix movement), we see that in the latter case there is always an overlap in the surface treatment. This overlap is due to the fact that the surface treatment, particularly by a plasma jet or similar, is not limited to one spot but has a two-dimensional expansion that is effective on the right and left side of the preferential direction. Thus, it is impossible to exactly switch-off after a rotation of the body, i.e. after turning about 360°, and to achieve a treatment that is 100% equally distributed with regard to the surface to be treated. The fact that the surface is not treated equally, with a different treatment dose in different areas, results in differing surface changes, which become noticeable by producing characteristics that differ from each other. In such a way, a print image of uniform quality cannot be achieved, e.g. due to the fact that, during subsequent printing, the color or ink will adhere to the surface with varying degrees of adhesion. Applying the treatment according to the invention in the form of a helical line achieves a distinctly more uniform surface treatment, because the surface areas are all treated in the same way.

Especially in connection with the clocked surface treatment, but also in connection with the continuous surface treatment, it can be provided, in accordance with a particularly preferred embodiment of the invention that a changer with at least two conveyor track sections is integrated into the conveyor track, whereby the changer is operated in such a way that in one conveyor track section an onward movement of a three-dimensional body or of three-dimensional bodies that have been picked up in the one conveyor track section is carried out, while in the other conveyor track section, the surface treatment of another three-dimensional body or of other three-dimensional bodies that have been picked up in the other conveyor track sections is carried out. The conveyor track sections are preferably logically arranged parallel to each other, but also preferably in terms of their spatial arrangement. This enables a virtually continuous operation of the surface treatment, because while the surface treatment on one conveyor track section is being carried out, the three-dimensional bodies that are in the other conveyor track section (and that have already been treated) are being moved on in the direction of printing or the printing machine/printing station. Consequently, the transport flow of three-dimensional bodies according to this proposal is divided into multiple, i.e. at least two but more if required, different conveyor track sections.

With more than two conveyor track sections, the surface treatment and the onward movement can occur in a phase-shifted manner relative to each other. This enables a particularly close approximation to a continuous process. This method can be used with a star wheel conveyor as well as with a longitudinal conveyor (translational transport).

In case of a longitudinal conveyor with two parallel conveyor track sections arranged spatially parallel to each other, it can be provided for the surface treatment apparatus to swivel from one conveyor track section to the other, e.g. by swiveling the surface treatment apparatus about 180°, so that the effective direction is exactly opposite. In this way, one surface treatment apparatus can simultaneously operate on two conveyor track sections. This enables an improved utilization of the expensive surface treatment apparatuses, e.g. for plasma treatment.

The invention further relates to a device for surface treatment of a three-dimensional body for preparation of a three-dimensional surface of the body for printing, particularly with ink, by a surface treatment apparatus for treating the entire surface to be printed, which preferably has a three-dimensional expansion itself. In the proposed device according to an embodiment of the invention, the surface to be printed is designed to be movable relative to the surface treatment apparatus. For the solution of the present task, it is especially provided that the device has a conveyor apparatus with a conveyor track for the three-dimensional body, and it is also provided for the surface treatment apparatus to be arranged in the area of the conveyor track. This enables achieving the advantages previously described in the context of the method description according to the invention.

According to an embodiment of the invention, it is provided for a continuous surface treatment, that the conveyor apparatus for the three-dimensional body, i.e. for the movement of the body along the conveyor track of the conveyor apparatus, has a carrying apparatus for moving the three-dimensional body past the surface treatment apparatus, and a movement apparatus for moving the three-dimensional body about its own axis. That means that the carrying apparatus and the movement apparatus are equipped to enable the movement of the three-dimensional body past the surface treatment apparatus and the movement of the three-dimensional body about its own axis to occur simultaneously. Due to these design features, the proposed method according to the invention can be realized by this device in a continuous manner. The carrying apparatus and the movement apparatus can also be realized by a combined apparatus, e.g. by suitable drives that achieve the combined movement of the body without requiring separate drives for the translational movement and the independent movement of the body.

Particularly for a clocked (discontinuous) surface treatment, the conveyor apparatus according to the invention can have a movement apparatus for moving the three-dimensional body about an independent body axis and an adjustment apparatus for the displacement of the three-dimensional body relative to the surface treatment apparatus in the direction of the body's own axis, which allows achieving the previously described surface treatment in the form of a helical line in a simple manner.

Systems and methods can also be envisaged according to the invention, in which a continuous and a clocked surface treatment, e.g. in different conveyor tracks or conveyor track sections, are combined with each other.

In a further development of the proposed devices according to the invention, the device can have a moving or fixed railing and a moving butting surface preferably arranged opposite the railing, so that the three-dimensional body can be received between railing and butting surface in a force-fit manner. The butting surface and/or the railing can be designed e.g. as a belt drive, whereby the belt drive that is forming the butting surface is abutting against the three-dimensional body preferably with initial tension. This can be achieved by a tensioning device that would put pressure on the belt in the direction of the three-dimensional body, e.g. in the form of rolls that are preloaded by springs or by way of utilizing a suitable belt guide. Alternatively, a separate roll drive or similar for each bottle is also possible. For example, driven rolls or counter-rotational rolls can also be used to function as butting surface and/or railing. The butting surface and/or railing can be designed also using any combination of rolls, belts, roll drives and belt drives. In an alternative or combined embodiment, the conveyor apparatus can be designed as a star wheel conveyor with a drive equipment for moving the three-dimensional body inside the star pocket of the star wheel conveyor. Here, particularly a roll drive or a separate rotary disc for each star pocket are possible solutions that can be realized in a technically simple way. However, the invention is not limited to these rotary drives for the independent motion of the three-dimensional body.

The surface treatment apparatus according to the invention can be an arrangement of multiple gas-fired burners, i.e. multiple individual burner nozzles, for flame treatment. A high quality surface treatment can be preferably achieved according to the invention, if the surface treatment apparatus is an arrangement of plasma emitters, especially for treatment with atmospheric plasma, whereby particularly rotating plasma emitters are used. With their rotating outlet nozzles, these plasma emitters create a treatment surface in the shape of a circular segment on the surface to be treated. Inside this circular segment, the surface is treated by the rotating plasma emitter with an approximately equal plasma intensity in a very homogeneous way.

As a particularly preferred arrangement of surface treatment apparatuses, the individual plasma emitters or burner nozzles can be arranged in preferably multiple, e.g. three, double rows. Each double row is arranged in such a way that the individual rows that form the double row are offset relative to each other by half a distance between the individual plasma emitters or burner nozzles. Thus, the arrangement is preferably realized in such a way that the double row completely covers one direction of the surface of the body to be printed transversely to the transport direction.

If multiple double rows are arranged in transport direction of the three-dimensional body, a particularly homogeneous distribution of the plasma or flame impact on the surface is achieved at comparatively short treatment times during the continuous transport of the three-dimensional body, as the treatment of the entire expansion of the surface to be printed can be distributed among several plasma emitters or burner nozzles in transport and/or movement direction.

The device according to an embodiment of the invention can be further equipped with a control equipment having a computing unit, whereby the computing unit is furnished with data processing software for performing the methods or variants of methods or parts of the methods described above.

In FIG. 1, bottles 1 are depicted as three-dimensional bodies that are transported along the conveyor track of a conveyor apparatus 2 at a transport speed v_{T} in a translational manner past a surface treatment apparatus 3. During the movement past the surface treatment apparatus 3, a surface of the bottle 1 later to be printed is pre-treated, so that the printing material (printing color or ink) can adhere to the surface according to the desired quality level. Please note that although the invention is described below based on the surface treatment of bottles as three-dimensional bodies 1 in different embodiments, it is not intended for the invention to be limited to this particularly preferred application.

The conveyor apparatus 2 has two belts 4, 5 that are driven by a motor, whereby belt 4 serves as railing and belt 5 serves as butting surface. Both belts abut against the three-dimensional bodies or bottles 1 from two opposite sides, whereby the butting surface 5 is pressing the bottles 1 against the railing 4.

Belt 5 that serves as butting surface is moving at a speed v₁ in the direction of the transport speed v_{T}. Belt 4 that serves as railing, against which the bottles 1 are pressed by the butting surface 5, is moving in relation to the butting point on the bottle 1 in the opposite direction of the butting surface speed v₁ at a speed v₂. Due to the fact that the belts 4, 5 move at different speeds, the belts, on the one hand, function as carrying apparatus that moves the three-dimensional body 1 (bottle) past the surface treatment apparatus 3. The transport speed v_{T} thereby results from the difference between the speed of the butting surface v₁ and the speed of the railing v₂, i.e. v_{T}=v₁−v₂.

Due to this speed difference, the three-dimensional body 1, i.e. the bottle, is simultaneously moved or turned about an independent axis that is identical with the rotationally symmetric axis of the bottle.

The circumference speed in the area of the surface to be printed results from the speed v₂ of the railing 4 relative to the speed v₁ of the butting surface 5. Therefore, due to their different speeds, the railing 4 and the butting surface 5 also act as a movement apparatus that moves the three-dimensional body 1 about its own body axis while simultaneously bringing about the translational movement (transport direction).

During the translational movement of the bottle 1 past the surface treatment apparatus 3, the circumference of the bottle is turning as well, while the bottle 1 is moved past the surface treatment apparatus 3. This enables the entire printing surface to be treated by the surface treatment apparatus 3 that is arranged on the side of the conveyor apparatus 2, so that the bottles 1 can subsequently be printed on the area of the three-dimensional surface of the three-dimensional body 1 in a printing station that is not depicted here.

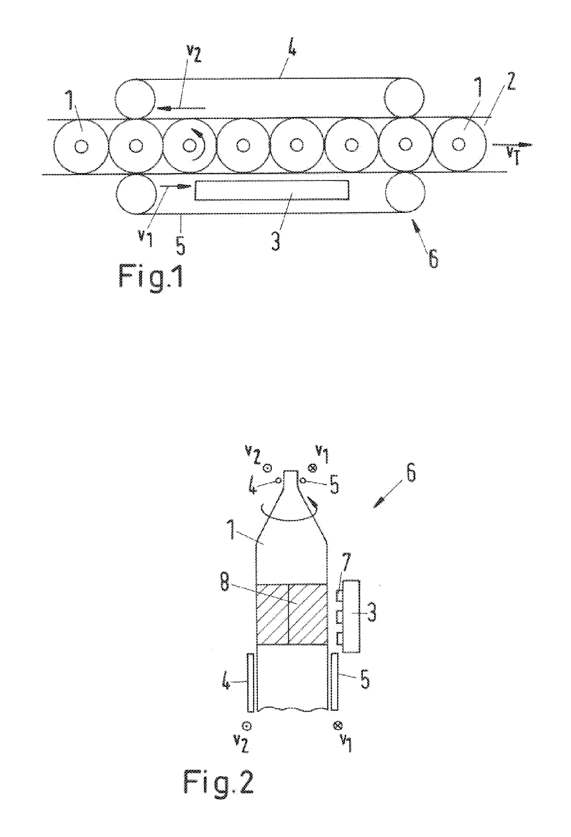

The device 6 according to the invention is also depicted in FIG. 2 in a side view, whereby the viewing direction points in the transport speed direction V_{T}. The bottle 1 is held between the railing 4 and the butting surface 5 in a force-fit manner, whereby the railing 4 is moving at the speed v₂ upward and out of the depicted surface towards the viewer, whereas the butting surface 5 is moving at the speed v₁ into the depicted surface of FIG. 2. The surface treatment apparatus 3 is arranged above the butting surface 5. It has multiple rotating plasma emitters 7 for creating an atmospheric plasma that impacts on the surface of the three-dimensional body 1 in the area to be printed 8.

In the bottleneck area of the bottle 1, further belts 4, 5 are provided for further guiding the bottle 1. These belts move at the same speeds as the railing 4 and the butting surface 5 in the same directions respectively. The independent motion of the bottle 1 is indicated by the arrow in the area of the bottleneck.

Due to the fact that the bottle 1 is moved past the plasma surface treatment apparatus 3 during its movement along the conveyor track in the conveyor apparatus 2, while simultaneously turning about its own axis, the entire surface to be printed 8 rolls along the surface treatment apparatus 3, so that the surface to be printed 8 is entirely treated by plasma.

In addition to the presented and described example, it is also possible that a conveyor apparatus moves the bottle 1 separately at a transport speed v_{T} and the independent motion is produced by the butting surface 5 with a fixed railing 4 or by the butting surface 5 and the railing 6 including a counter-movement of the railing 4. This enables the turning speed of the bottle 1 to be changed by changing the speeds v₁, v₂ of the butting surface 5 and/or the railing 4. This has also an effect on the treatment time for the surface treatment of the surface to be printed 8. The treatment time can thus be set to a suitable duration according to the invention.

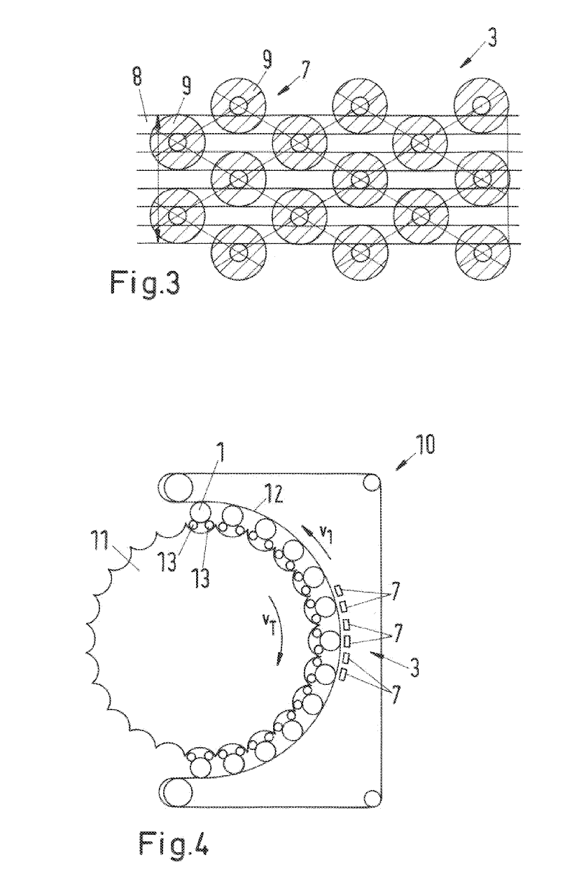

An especially preferred arrangement of the surface treatment apparatus 3 can be seen in FIG. 3 that shows a top view of the surface treatment apparatus 3 with the rotating plasma emitters 7. These plasma emitters 7 are arranged in an arrangement (array) that consists of three double rows of plasma emitters 7 that are offset by half their distance relative to each other, so that a total of six rows of plasma emitters 7 is arranged one after the other.

Due to the rotational movement of the plasma emitters 7, the plasma emitters 7 each create a circular segment 9 of a plasma treated surface during the outlet nozzle's rotation of the plasma emitters 7. Plasma emitters 7 of this type are known and can be commercially purchased. The surface treated as circular segment 9 is depicted in FIG. 3 as a dashed surface.

Due to the simultaneous movement of the surface to be printed 8 consisting of the combined translational movement and independent movement of the bottle 1, the entire surface to be printed 8 is covered by the arrangement shown in FIG. 3.

For example, the transport speed v_{T}, the speed v₁ of the butting surface 5 and the speed v₂ of the railing 4 can be adjusted such that a label with the width of 70 mm travels over six plasma emitters 7 in such a way that 7 strips of 10 mm width each are exposed to the impact of six plasma emitters, in order to achieve a plasma treatment that is as even as possible. As a label can be up to 300 mm long, every traveling track of the plasma emitter 7 has to cover a minimum of 300/6 mm. Therefore, the bottle 1 has to be turned about 50 mm further per travel over a burner. During this time, the rotating plasma emitter 7 should have performed five revolutions.

This configuration is a concrete and preferred example for a typical parameterization of the device according to the invention or for the realization of the method for surface treatment of three-dimensional bodies 1 according to the invention, without the invention being limited to exactly this configuration.

Finally, FIG. 4 shows an alternative device 10 for surface treatment of three-dimensional bodies 1 (bottles), featuring a star wheel conveyor 11 as conveyor apparatus. The star wheel conveyor turns at a transport speed v_{T}, thus creating a circular conveyor track. A belt 12 is moved in the opposite direction of the transport speed v_{T}. This belt is driven by a motor and presses the bottles 1 into the rolls 13 (counter-rotational rolls) that serve as railing.

Therefore, the motor-driven belt forms the butting surface 12 of the device 10 and moves in the opposite direction of the transport speed v_{T} at a speed v₁. Due to this counter-rotating speed, the bottle 1 is not only moved with a translational movement along the conveyor track of the star wheel conveyor 11, brought about by the turning of the star wheel conveyor 11, but also with a rotational movement about its own symmetry axis.

During this combined movement, the bottle 1 with the surface to be printed 8 is moved past a surface treatment apparatus 3 that consists of multiple plasma emitters 7. Arrangement and functionality of the surface treatment apparatus 3 correspond to the embodiment described above. Therefore, this does not require detailed explanation.

Instead of plasma emitters 7, the surface treatment apparatus 3 could also have gas-fired burners, so that instead of a plasma treatment, a flame treatment is performed. The arrangement of the burners in an array could be realized in the same manner.

Such a flame treatment is suitable for preparation of a surface for printing with ink in the same way as a plasma treatment.

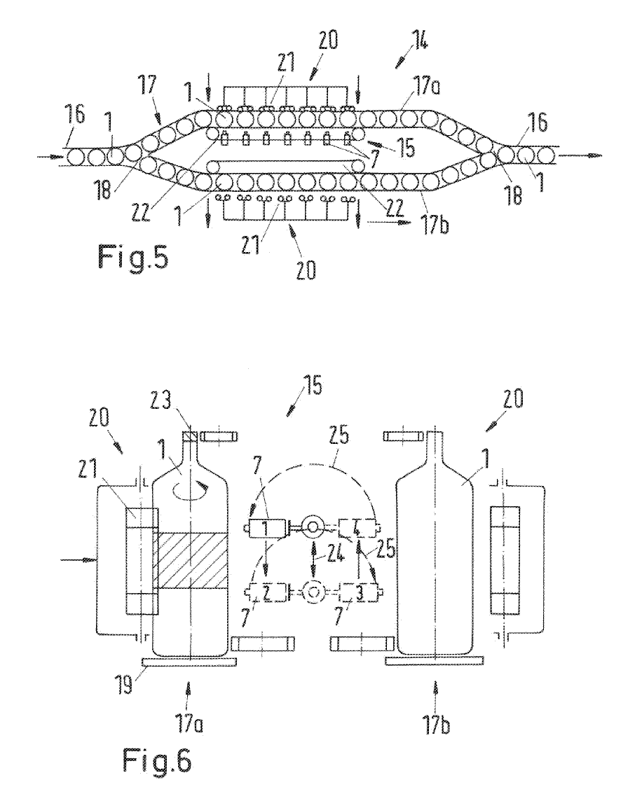

In FIG. 5, a further embodiment of a device 14 according to the invention is shown. This device is also for surface treatment of bottles 1 as three-dimensional bodies, in order to prepare the surface of the bottle 1 for a subsequent printing in a printing station or printing system that is not depicted in FIG. 5. For that purpose, a surface treatment apparatus 15 is provided in device 14 that has several individual plasma emitters or plasma nozzles 7 arranged in an arrangement (array). The impact direction of these plasma emitters can be orientated toward the bottles 1. Furthermore, the device 14 according to the invention has a conveyor apparatus with a conveyor track 16 for the bottles 1, whereby the surface treatment apparatus 15 is arranged in the area of the conveyor track 16.

The conveyor track 16 has a changer 17 with two conveyor track sections 17a and 17b, which enter into the single-duct conveyor track 16 via a switch-like branching 18.

In the front branching 18 in transport direction, the bottles 1 that are being moved on the conveyor track 16 in the direction shown by the arrows can be distributed among the two conveyor track sections 17a and 17b. The surface treatment apparatus 15 is arranged in the area of the conveyor track sections 17a and 17b of the entire conveyor track 16, so that in the status shown in FIG. 5, it impacts the bottles 1 that were fed into the conveyor track section 17a.

The conveyor apparatus has a carrying apparatus 19 that is shown in FIG. 6 for moving the bottles 1 along the conveyor track 16 or the conveyor track sections 17a, 17b. This carrying apparatus is designed as a type of a belt conveyor. In the area of the surface treatment apparatus 15, there is also a movement apparatus 20 provided for moving the bottles 1 about an independent body axis, i.e. a movement apparatus for rotating the bottle 1 about its independent symmetry axis. This apparatus turns the bottle 1 in such a way in front of the plasma emitters 7 of the surface treatment apparatus 15 that the surface to be printed 8 of the bottles 1 can be treated by the plasma emitters 7.

The movement apparatus 20 for rotating the bottles 1 in front of the plasma emitters 7 has counter-rotational rolls 21 that are arranged opposite the plasma emitters 7 and that function as a railing. A motor-driven belt 22 functions as butting surface that is interacting with the counter-rotational rolls 21. The bottles 1 are held between the belt 22 and the counter-rotational rolls 21 in such a way that the butting surface 22 (belt) abuts against the bottles 1 in a force-fit manner and sets them in rotation by the motion of the belt 22. During this rotation, the carrying apparatus 19 in the conveyor track section 17a is not in operation, so that the rotating bottle 1 is standing still relative to the transport movement along the conveyor track 16, 17a. This operation type is therefore also called discontinuous or clocked surface treatment, because the bottle 1 is not being transported further during the surface treatment.

However, while the treatment in the conveyor track section 17a is taking place, it is possible to reintegrate the bottles 1, which already have been treated in the conveyor track section 17b, into the conveyor track 16 via the branching 18 of the changer 17, so that in this way a quasi continuous operation is achieved, because the bottles 1 are supplied to the printing machine or printing station continuously, although a clocked surface treatment in the area of the changer 17 is taking place.

For surface treatment of the bottles 1 in the conveyor track section 17b, the surface treatment apparatus 15 is turned about 180°, so that the plasma emitters 7 then are directed onto the bottles 1 in the conveyor track section 17b. A movement apparatus 20 for rotation, with counter-rotational rolls 21 and a motor-driven belt 22, is also provided in the conveyor track section 17b similar to that in conveyor track section 17a.

The structure of the surface treatment apparatus 15 with the movement apparatus 20 is shown again in the sectional view according to FIG. 6 in more detail. It shows one bottle 1 in each of the conveyor track sections 17a and 17b. In each of the conveyor track sections 17a, 17b, a movement apparatus 20 is provided for rotating the bottle. The movement apparatus has counter-rotational rolls 21 and a motor-driven belt 22, whereby one belt 22 is arranged opposite the counter-rotational roll 21 near the bottom and one on the bottleneck, in order to press the bottle in a force-fit manner against the counter-rotational roll 21 and to keep the surface to be printed 8 free for treatment by the plasma emitters 7. In the conveyor track section 17a, the belts 22 and the counter-rotational rolls 21 abut tightly against the bottle 1, so that the bottle 1 is set in rotation about its body's own axis (central axis) 23. The plasma emitter 7 is in the position 1 and is treating the surface 8 to be printed or treated along its upper rim.

In order to achieve an equal dose of the plasma treatment, or, more generally, of the surface treatment within the framework of the surface treatment, it is provided that the bottle 1 and the surface treatment apparatus 15 with the plasma emitters 7 travel to the position 2 in the direction of the body's own axis 23, being moved by an adjustment apparatus 24, indicated by the double arrow, while the bottle 1 is rotating and the plasma emitter 7 is treating the surface 8. In this way—provided that the rotational speed of the bottle about its own central axis 23 is suitable and the adjustment speed of the adjustment apparatus 24 is right—treatment tracks of the plasma emitter 7 in the form of a helical line are created on the surface 8, whereby every area on the entire treatment surface 8 is treated in a uniform way with an equal intensity dose and treatment duration.

During this treatment, the carrying apparatus 19 is not operating, i.e. the bottle is resting in the treatment position with regard to its movement in transport direction and only performs a rotation about its own axis 23. After the treatment of the bottle 1 or, as shown in FIG. 5, of multiple bottles 1 arranged next to each other, the surface treatment apparatus 15 is swiveled along the dotted arrow 25 about 180°, so that the plasma emitter 7 moves into position 3 according to FIG. 6. While the plasma treatment in the conveyor track section 17a is taking place, in conveyor track section 17b, the counter-rotational rolls 21 and the belts 22 are retracted from the bottles 1. The bottles 1 that have already been treated in a previous surface treatment step in the conveyor track section 17b are moved out of the conveyor track section 17b and new bottles 1 are simultaneously introduced into the conveyor track section 17b.

During the swivel movement 25 of the surface treatment apparatus 15 described above, or immediately prior to it or after it, the counter-rotational rolls 21 and the belts 22 of the conveyor track section 17b are abutted against the bottle 1 and the treatment described above for the conveyor track section 17a is performed. The plasma emitter 7 travels from position 3 into position 4 moved by the adjustment apparatus 24, so that treatment tracks in the form of a helical line are also created on the treatment surface 8 of the bottles 1. During the surface treatment in the conveyor track section 17b, the bottles 1 from the conveyor track section 17a are exchanged correspondingly.

This particularly advantageous configuration of a clocked conveyor track section 17a, 17b makes a quasi continuous operation possible, as the printing machine or printing station arranged downstream receives bottles 1 from conveyor track section 17a or from the conveyor track section 17b for printing in a quasi continuous manner.

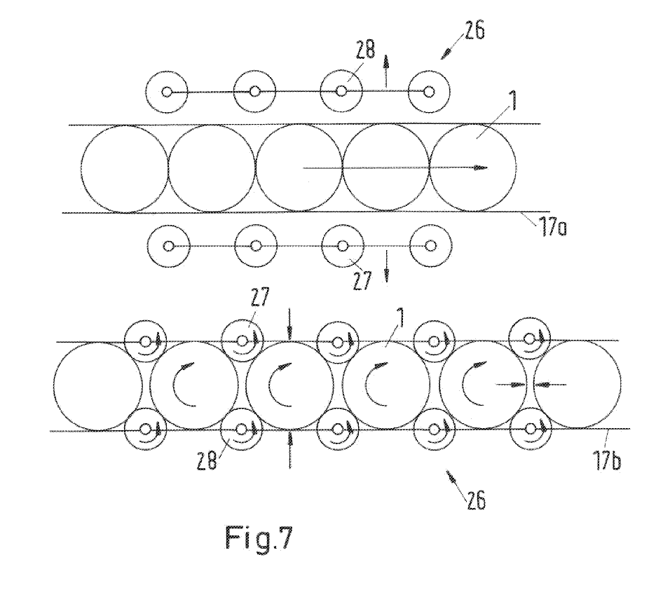

FIG. 7 shows a variant of the device 14 according to the invention in a top view, with an alternative movement apparatus 26 arranged correspondingly in the conveyor track sections 17a and 17b.

With the exception of the movement apparatus 26, this embodiment is identical to the device 14 shown in FIGS. 5 and 6. Therefore the same reference numerals have been used and also only the changed movement apparatus 26 for rotation has been depicted in more detail.

The conveyor track section 17a (shown above) is depicted in a state, in which the bottles 1 are transported along the conveyor track section 17a by the carrying apparatus 19 in the direction of the arrow. The movement apparatus 26 with driven rolls 27 and counter-rotational rolls 28 does not abut against the bottles 1, so that they can be freely transported along the conveyor track section 17a.

In the conveyor track section 17b, a surface treatment of the bottles 1 is taking place while in conveyor track section 17a the bottles 1 are moved or changed at the same time, whereby the surface treatment apparatus 15 is not depicted for reasons of greater clarity. Correspondingly, the driven rolls 27 and the counter-rotational rolls 28, which can also be driven if required, are abutting against the bottles 1, whereby the distance between two driven rolls 27 and two counter-rotational rolls 28 is fixed in such a way that the bottles 1, while being rotated by the movement apparatus 26 as bottles 2, have a certain safety distance between each other in the range of e.g. approximately 1 mm, so that the bottles do not rub against each other while being rotated during surface treatment. The distance of the driven rolls 27 and of the counter-rotational rolls 28, which are possibly driven themselves in a co-rotating direction, is furthermore fixed in such a way that the two adjacent driven rolls 27 do not cause a stoppage of the bottle rotation.

For example, in order to effect a distance of 1 mm between each of 24 simultaneously treated bottles, when abutting the rolls 27, 28 against the bottles 1, the movement apparatus 26 has to displace the first and the last bottle about 12 mm to the front and to the rear respectively, based on the center bottle 1. This margin is available in the conveyor track sections 17a, 17b.

During the surface treatment in the conveyor track section 17b, the carrying apparatus 19 stands still, so that the bottles are resting in transport direction and are only rotating on a fixed position.

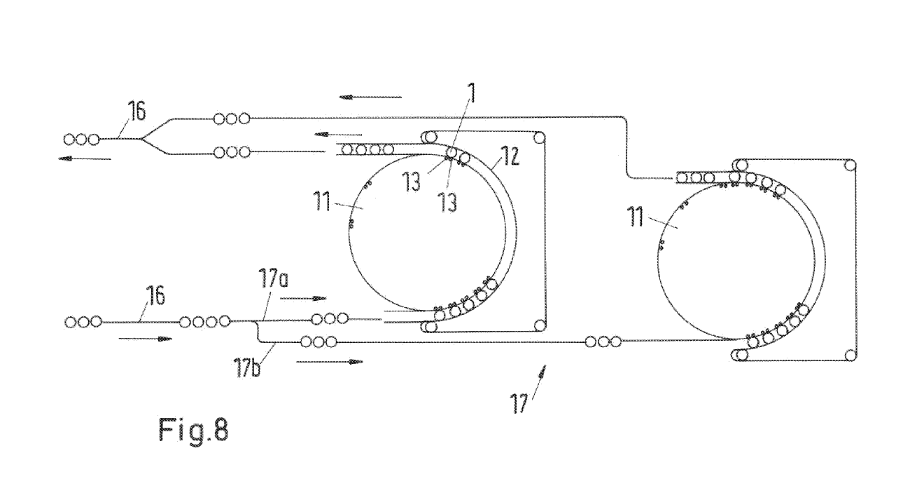

Finally, FIG. 8 shows a further device 29 according to the invention, that is designed in a similar way as device 10 of FIG. 4. This device is also intended for a clocked, discontinuous surface treatment. Two star wheel conveyors 11 are provided in a changer 17 with two conveyor track sections 17a and 17b that enter into a conveyor track 16 of a conveyor apparatus.

At each of the star wheel conveyors 11, a surface treatment apparatus e.g. corresponding to the one shown in FIG. 4 is provided, but not depicted here. The bottles 1 are held inside the star wheel conveyor 11 in counter-rotational rolls 13 that serve as railing while the rotational drive is provided by a motor-driven belt that serves as butting surface 12. The belt presses the bottles against the rolls 13 of the star wheel conveyor 11.

Thus, the bottles can be set in rotation by the driven belt 12, whereby this also can happen while the star wheel conveyor 11 is standing still. In this case, the surface treatment apparatus has to be provided in a movable version, corresponding to the representation e.g. in FIG. 5. This will ensure that along the rotation axis of the bottles 1, treatment tracks in the form of a helical line are created inside the treatment area of the surface 8 of the bottle 1.

This embodiment according to FIG. 8 has the advantage that the bottles, when being received into the star wheel conveyor 11 by means of abutting the bottles against the rolls 13, do not have to be displaced as far as in case of the embodiment according to FIG. 7. However, due to the parallel arrangement of two star wheel conveyors 11, also two surface treatment apparatuses are required

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 three-dimensional body, bottle
2 conveyor track of a conveyor apparatus
3 surface treatment apparatus
4 motor-driven belt, railing
5 motor-driven belt, butting surface
6 device for surface treatment
7 plasma emitter
8 surface to be printed
9 circular segment
10 device for surface treatment
11 star wheel conveyor
12 motor-driven belt, butting surface
13 roll, railing, counter-rotational roll
14 device for surface treatment
15 surface treatment apparatus
16 conveyor track
17 changer
17a,b conveyor track sections
18 branching
19 carrying apparatus
20 movement apparatus for rotation
21 counter-rotational rolls
22 motor-driven belt, butting surface
23 center axis, body's own axis
24 adjustment apparatus
25 swiveling
26 movement apparatus for rotation
27 driven rolls, butting surface
28 counter-rotational rolls, railing
29 device for surface treatment
v_{T} transport speed
v₁ butting surface speed
v₂ railing speed

1-16. (canceled)

17. A method for surface pretreatment of a three-dimensional body for preparing a three-dimensional surface of the body for printing, the method comprising: for purposes of at least one of cleaning or adaptation to a surface voltage of a printing material, moving the surface to be printed relative to a surface treatment apparatus so that the whole of the surface to be printed is treated, wherein the three-dimensional body is treated in a conveyor track of a conveyor apparatus with a surface treatment, and wherein the three-dimensional body is moved past the surface treatment apparatus along the conveyor track of the conveyor apparatus at an adjustable transport speed in a transport direction and is simultaneously moved about its own axis in such a way that the surface to be printed is moved past the surface treatment apparatus in or against the transport direction due to the independent movement of the body about its own axis.

18. The method according to claim 17, wherein the three-dimensional body is rotated about its own axis.

19. The method according to claim 17, wherein the movement of the body about its own axis is brought about by rolling the three-dimensional body against a railing, due to the motion of a moving butting surface that abuts against the three-dimensional body.

20. The method according to claim 19, wherein the railing is moved in the direction of or opposite to the direction of the butting surface.

21. The method according to claim 19, wherein the movement of at least one of the butting surface or the railing is brought about by a motor-driven belt.

22. The method according to claim 17, wherein the transport speed and the independent movement are coordinated such that the surface treatment apparatus treats every area of the surface to be printed for approximately at least one of a same length of time or a same intensity.

23. The method according to claim 17, wherein a surface pre-treatment of the three-dimensional body is performed in a direction of the conveyor track during a standstill, wherein the three-dimensional body is moved about its own axis while being simultaneously moved past the surface treatment apparatus and wherein, during the movement of the three-dimensional body about its own axis, the three-dimensional body and the surface treatment apparatus are displaced relative to each other in the direction of the body's own axis, whereby a speed of the movement about the body's own axis and a speed of the displacement movement along the axis are coordinated such that the surface of the three-dimensional body is treated by the surface treatment apparatus in the form of a helical line.

24. The method according to claim 17, wherein a changer with at least two conveyor track sections is integrated in the conveyor track, the changer being operated in such a way that in one conveyor track section a three-dimensional body is being transported further, while in the other conveyor track section the surface pre-treatment of another three-dimensional body is taking place.

25. A device for surface pre-treatment of a three-dimensional body for preparing a three-dimensional surface of the body for printing by a surface treatment apparatus for treatment of the whole of the surface to be printed, in which device the surface to be printed is arranged to be movable relative to the surface treatment apparatus, the device comprising: a conveyor apparatus with a conveyor track for the three-dimensional body, the surface treatment apparatus being arranged in an area of the conveyor track, the conveyor apparatus having a carrying apparatus configured to move the three-dimensional body past the surface treatment apparatus and a movement apparatus configured to simultaneously move the three-dimensional body about its own axis.

26. The device according to claim 25, Wherein the conveyor apparatus has an adjustment apparatus configured to provide a relative displacement of the three-dimensional body and surface treatment apparatus in the direction of the body's own axis.

27. The device according to claim 25, wherein the conveyor apparatus has a changer in the conveyor track, the changer having at least two conveyor track sections, wherein each conveyor track section is assignable to a surface treatment apparatus.

28. The device according to claim 25, wherein the conveyor apparatus has a moving or fixed railing and a moving butting surface, between which the three-dimensional body is receivable in a force-fit manner.

29. The device according to claim 25, wherein the conveyor apparatus is designed as a star wheel conveyor with a drive equipment for moving the three-dimensional body in a star pocket of the star wheel conveyor.

30. The device according to claim 25, further comprising a control equipment with a computing unit, wherein the computing unit is configured to execute a method for the surface pretreatment of the three-dimensional body for preparing the three-dimensional surface of the body for printing, the method comprising, for purposes of at least one of cleaning or adaptation to a surface voltage of a printing material, moving the surface to be printed relative to the surface treatment apparatus so that the whole of the surface to be printed is treated, wherein the three-dimensional body is treated in the conveyor track of the conveyor apparatus with a surface treatment, and wherein the three-dimensional body is moved past the surface treatment apparatus along the conveyor track of the conveyor apparatus at an adjustable transport speed in a transport direction and is simultaneously moved about its own axis in such a way that the surface to be printed is moved past the surface treatment apparatus in or against the transport direction due to the independent movement of the body about its own axis.
